(19) United States
(12) Patent Application Publication
(10) Pub. No.: US 2026/0221764 A1
(43) Pub. Date: Jul. 30, 2026

(54) Residential DC Voltage Infrastructure

(71) Applicant: Ronald Edmund Patton, Inning (DE)

(72) Inventor: Ronald Edmund Patton, Inning (DE)

(21) Appl. No.: 19/140,839

(22) PCT Filed: Jan. 8, 2024
(86) PCT No.: PCT/IB2024/000087

§ 371 Date: Jun. 19, 2025

(51) Int. Cl. H02J 1/082; H02H 7/26

(52) U.S. Cl. CPC H02J 1/082; H02H 7/268

(57) ABSTRACT

The HomeDC residential DC voltage infrastructure invention is concerned with the electrification of a normal residence or office. Currently homes have A/C sockets throughout and the socket, by which typically 120V AC or 230V AC at 50 or 60 Hz is available, provides electrical power. However, many lower-power devices and lighting use DC voltage internally and thereby require an internal AC/DC conversion. Including a DC voltage infrastructure in the home and office could make all these lower-power DC devices simpler, less costly to develop and to certify and consequently less expensive to buy and to operate. This could allow bedrooms, living and dining rooms to be essentially free of A/C voltages. The higher-power devices and major appliances in the home are still most suited for A/C voltages. But these devices are mostly found in the kitchen, laundry, and utility rooms. Additionally, compared to DC, A/C voltages are dangerous and even sometimes lethal.

### SUMMARY OF THE HOMEDC INVENTION

In a normal residence AC wiring with 230 VAC or 120 VAC, depending on the country, is distributed throughout. Many of the electrical devices in the house, however, use DC voltage (LED lighting, home entertainment, computers, printers, mixers, blenders, battery chargers, etc.). The HomeDC invention will provide a residential infrastructure so that these devices do not need to be converted to DC from AC as is currently the case. This conversion, due to the safety and electromagnetic compliance issues of 120 VAC or 230 VAC, is costly and requires certification of several norms. In many rooms the DC voltage is all that is required. Additionally, the user has the option to select one of the two 24 VDC circuits or the 48 VDC at each electrical plug, optimizing the use of the available DC power.

### DETAILED DESCRIPTION OF THE INVENTION

The power is always composed of two separate 24 VDC power supplies connected as follows:

### Supplies (AC/DC Power Supply, Batteries, Other DC Voltage Sources, and Fuel-Cells)

### HomeDC Plug

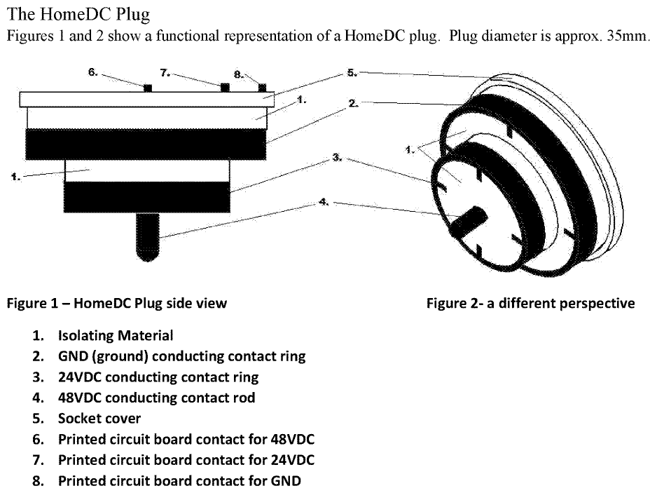

The plug in FIG. 1 shown above can come in the following versions.
1. 48 VDC; connects to red (+) and black (−) connector.
2. 24 VDCHi; connects to red (+) and red/black (−) connector.
3. 24 VDVLo; connects to red/black (+) and black (−) connector.
4. A plug with jumpers to select any of the three variants above.
5. In special cases it might be most efficient to have another plug type for higher-power devices with 48V for the higher power and 24 VDCLo for the control circuitry.

For 24 VDC, distribute the loads between numbers 2 and 3. This allows the user to optimize a single circuit's load spread.

### Notes

A sixth plug type, where all contacts are present, will be used only for extension cords or the HomeDC desk set.

This HomeDC plug is designed to be unique in that users will have no problem distinguishing this plug from A/C voltage plugs. The following components are not shown:
1. A printed circuit board (PCB) containing:
   a) Transistor(s) to prevent arcing and additional capacitors, resistors, etc.
   b) Mechanical switch to connect or disconnect selected voltage from its device.
   c) Wire connectors (usually 2-pole PCB terminal block with levers) for selected output DC voltage (plus 24V or 48V, red and minus voltage black)
   d) A version of the PCB could contain jumpers to select the desired DC voltage.
   e) Possible status LED(s).
2. A raised mechanical component to facilitate a twist motion to insert or remove plug.
   a) Connects to the plug on two sides and protects the PCB below.
   b) The mechanical switch could be integrated into this component.
   c) A bifurcation on the other end of this component could be used as the wire exit.
3. A dust cover which has the following functions:
   a) It covers the PCB and prevents moisture from contacting the circuitry.
   b) Allows viewing of status LED(s).

### HomeDC Socket

As mentioned above, the plug should be the same for all countries worldwide. The socket is a receptacle with two concentric cylindrical depressions which exactly correspond to the dimensions of the plug. The lower part of each cylinder's edge has a ring of low-resistance spring contact metal which connects to ground and 24V. Below the second ring there is an insulating plastic surface with a hole for the 48V rod. Below the plastic surface is a clamp connected to the RED wire for 48 VDC. The plastic surface below the lower ring is to prevent human fingers from touching anything more than 24V. The lower cylinder connects to RED/BLACK wire for 24 VDC, and the uppermost cylinder connects to the BLACK wire for ground. The plug must fit snugly into the socket and the socket's three connectors must make a low resistance contact with the corresponding plug contact. There will be two 3-pole PCB terminal blocks with levers (wire connectors) on each side of the socket so that additional sockets can be added to the same circuit.

The socket, where it mates with the plug, will also always be the same. However, there must be some adaptation depending on the country. The socket unit should fit into the normal electrical box used for the A/C voltages and switches in that country, if possible. Otherwise, special HomeDC electrical boxes must be developed.

### Connecting Wires Between HomeDC Plug and DC Load

Typically, the user would use a flexible multistrand copper wire with an effective cross-sectional area of 2.5 mm². The current rating would be up to 10 A or 240 W with a 24 VDC load and 480 W for a 48 VDC load. As mentioned above, there is one wire with black insulation (ground or 24V) and a second with red insulation (24V or 48V). Note, see exception for 3-wires mentioned above (48V, 24V and GND). Outside color can be arbitrary since the HomeDC plug is distinct. The 2-pole PCB terminal block with levers in the plug are suitable for do-it-yourselfers as far as safety is concerned. It is important, however, that a plug set up for 24 VDC is not connected to a 48 VDC load and vice versa. Additionally, 24 VDC loads should be distributed evenly as possible between 24 VDCHi and 24 VDCLo.

### HomeDC Wire in the Walls

HomeDC wire is just the same as other wire used in the home. Initially, copper wire with a 2.5 mm² cross-sectional area (or AWG14/AWG12) will be considered. For installations in the wall 3 solid-core copper wires are to be used. The insulation colors of the three wires are;
Red for +48 VDC
Red/black stripes for +24 VDC
Black for Ground

To additionally distinguish the DC wires from AC wires used in the residential installation the color of the outside insulating sheath must have a distinct color not used for the AC wires. A vivid green might be a good selection. This could vary from country to country, depending on the local electrical codes.

### Requirements for HomeDC Power Sources

### 1. AC/DC Power Supplies

The optimal AC/DC HomeDC power source will consist of a single device, optimally to be installed onto AC rails in a separate ventilated electrical enclosure. It will have two 24 VDC outputs mounted in series to provide the three different voltages, as stated above, for a total output power of 720 W per circuit. The outputs shall be protected by 15 A fuses or circuit breakers. This device will meet all the safety and EMC requirements for the country where it is installed.
The use of two separate 24 VDC supplies is also acceptable if they meet the requirements stated above and are allowed to be connected in series. A power supply consisting of two 1500 W 24 VDC units should be suitable for a single-family home or apartment with four HomeDC circuits.

### 2. Batteries

Batteries are an optimal power source. Batteries used in the storage of energy from solar arrays often use 24 VDC. As above it must be possible to connect two such batteries in series. The two batteries can drive multiple HomeDC circuits, depending on their capacity.

### 3. Fuses or Circuit Breakers

In any case each circuit must be protected by 15 A fuses or circuit breakers. There must be a physical switch and the fuse or circuit breaker must be suitable for 24/48 VDC voltages. The current at the 48V pole is measured flowing toward the load, at GND the current is measured flowing back from the load and the middle 24V pole current must be measured bi-directionally.

### 4. Optional Current Measurement

For people who wish to get the most out of each HomeDC circuit it would be possible to measure the current in each circuit for AC/DC converters as well as batteries as in sections 1 and 2 above. There could be a small display on the output of each circuit in its enclosure and/or displayed via an App on a smartphone via Wi-Fi. Integrating fuses/circuit breakers and current/voltage measurement for power distribution into one unit provides an optimal solution.

### 5. Grid Independence

With solar arrays and 24V batteries at the residence it would also be possible to keep the AC and the DC circuits separate, i.e. no AC/DC power supply; the AC for the major appliances (heating, washing machine dryer, oven, hair dryers, etc.) and HomeDC for the rest.

### HomeDC Lighting and Dimmers

To get the maximum benefit from HomeDC it will be necessary to make a standard for HomeDC 24 VDC light bulbs and light sockets ceilings, walls and outside. One solution would be to consider the common E14 and E27 bulbs. A possible solution for the HomeDC standard would be to reverse the direction of the threads both in the bulb and in the light socket. In any case the HomeDC bulbs and sockets must not work for traditional AC bulbs. Additionally, some lights must be dimmable. Typically, a third wire connects the dimmable light switch with the socket where a PWM signal sets the amount of dimming as described below.

Under normal circumstances the user should consider using the 24 VDVHi circuit for all lighting. Lighting can generally be considered as the lowest load in a household. In situations where a ground reference is needed the user must use 24 VDCLo and 48 VDC as both voltages have GND as the reference. Non-lighting loads use 24 VDCLo and can be switched to 24 VDCHi to optimize balance.

The wires between the light switch(s) and the lights can have a smaller diameter than the 2.5 mm² depending on the expected load. Again, a wire with red insulation for the plus terminal (48 VDC) and black for the minus terminal (24 VDC). A third wire would be necessary for dimming and switching. This control wire could be white. Multiple light switches on the same lighting circuit could control a single light with a control voltage of 5V (24 VDC+5V). Any switch pulling the 5V to the minus terminal momentarily would toggle the light's state (on or off). The same 5V operating voltage could be used in dimming circuits using pulse wave modulation (PWM).

### HomeDC Computer Desk Set for Home and Office

Most homes/offices have a desk with computer, monitor(s), lights, and places to recharge electronics. A HomeDC Computer Desk Set has one HomeDC plug but with all three wires included, and a cable connected to an object like a power strip. There is a socket for a docking station and a USB-C cable outlet for powering a laptop (<=130 W). There would also be HomeDC sockets for monitors and lighting as well as HomeDC Variable USB-C Chargers described below. These can be plugged directly into Smartphones or other rechargeable devices.

Two such HomeDC Computer Desk Sets would work together on one circuit.

### HomeDC Variable USB-C Charger

Currently, a USB-C charger negotiates charging current and voltage with the device to be charged. Common charger voltage/currents are 20V@3 A (60 W), 15V@3 A (45 W) and 5V@2 A (10 W). The HomeDC charger is built around the normal HomeDC plug and has a DPDT switch to select 24 VDCHi or 24 VDCLo. There is an integrated multi-color LED which shows what the current charging voltage and current is. There is also an up-arrow button and a down-arrow button. First, the user can select which of the two 24 VDC circuits he wishes to use via a DPDT switch. Then, if the user wishes to add an additional load to the circuit and the circuit already is highly loaded, he can press the down-arrow button and the maximum charging power is decreased one step in the charger and the LED color changes. In the opposite situation the user can press the up-arrow button to increase the maximum charging power. The LED color changes accordingly.

Retrofitting Homes with AC Wiring

As with normal AC wiring in a home or office, HomeDC also uses three wires with the same current-carrying capacity. An electrician would consult with the homeowner to determine which circuits could be converted. He can replace the current plugs, sockets, switches, and light fixtures with HomeDC equipment. The logical base for wire selection is as follows:
Line: +48V
Return: +24V
Protective Earth: 0V (Ground)

As the circuits are altered the electrician must use HomeDC shrink tubing. He must consider the suitability of retrofitting in every case and circuit. It is important to place the power supply as close as possible to the intended loads. If any of the three voltages on a particular circuit drops 5% or more @15 A load the circuit is not suitable for retrofitting.

1. A direct current (DC) voltage infrastructure system for supplying power to multiple DC-powered devices, the system comprising:
a DC power source configured to output a plurality of different DC voltages relative to a common ground reference;
a three-conductor electrical wire coupled to the DC power source and configured to distribute the plurality of DC voltages throughout a residence or office; and
at least one overcurrent protection device configured to interrupt electrical current between the DC power source and the three-conductor electrical wire in response to an overload or short circuit condition.

2. The system according to claim 1, wherein the plurality of DC voltages comprises a first voltage of approximately 48 VDC, a second voltage of approximately 24 VDC, and the common ground reference (GND or 0 VDC), and wherein the DC power source comprises two 24 VDC supplies connected in series to provide the first and second voltages.

3. The system according to claim 1, wherein the at least one overcurrent protection device comprises a set of three DC fuses or bidirectional circuit breakers.

4. The system, according to claim 1, further comprising an optional power distribution circuit integrated with the at least one overcurrent protection device, the power distribution circuit configured to measure power distribution (voltage, current) of the system and transmit data to a home energy management system via a wireless or wired connection.

5. The system according to claim 1, wherein the three-conductor electrical wire comprises solid-core copper with a cross-sectional area of approximately 2.5 mm² (or approximately AWG 12 or AWG 14), the conductors differentiated by insulation colors comprising a red color for the first voltage, alternating red and black colors for the second voltage, and a black color for the ground reference.

6. A DC electrical socket configured to connect to the three-conductor electrical wire according to claim 5, the socket providing access to the plurality of DC voltages.

7. A 3-contact DC plug configured to mate with the DC electrical socket according to claim 6, the plug providing the required DC voltages to an external device requiring 24 VDC and/or 48 VDC.

8. The DC plug according to claim 7, further comprising a printed circuit board (PCB) with circuitry configured to prevent electrical arcing during connection and disconnection and to facilitate switching on and off the selected voltage(s).

9. The DC plug, according to claim 8, further comprising a mechanical switch coupled to the printed circuit board (PCB), the switch configured to control power delivery to the external device via the PCB circuitry.

10. The DC plug, according to claim 8, further comprising an optional mechanical DPDT switch mounted on the PCB, the switch configured to select between 24 VDCHi (red and red/black wires) and 24 VDCLo (red/black and black wires) to optimize circuit loading.

11. The system according to claim 1, further comprising a DC light switch or dimmer configured to connect to the three-conductor electrical wire according to claim 5, the switch providing positive and negative terminals for a lighting wire utilizing the first voltage (48 VDC) and the second voltage (24 VDC) or 24 VDCHi.

12. The system according to claim 11, further comprising a three-conductor DC lighting wire comprising solid-core copper with a cross-sectional area of approximately 1.0 mm² and insulation colored red for the positive terminal conductor, black for the negative terminal conductor and white for the control terminal conductor, Lighting wire is configured for connection to the light switches or dimmers.

13. The system, according to claim 12, further comprising DC-specific light sockets configured to connect to the three-conductor DC lighting wire, wherein the DC-specific light sockets have optimally a non-standard physical configuration that mechanically prevents engagement with standard AC light sources and AC light sockets.

14. The system, according to claim 13, further comprising DC-specific light sources (“bulbs”) configured to mate with the DC-specific light sockets, wherein the DC-specific light sources have a non-standard physical configuration that mechanically prevents engagement with standard AC light sockets.

15. The system, according to claim 6, further comprising a modular DC desk set power strip configured to receive power via the DC electrical socket.

16. The system, according to claim 6, further comprising a variable USB-C charger configured to receive power via the DC electrical socket.

17. A method for retrofitting selected AC circuits within a building with a residential DC voltage infrastructure system, the method comprising:
Identify DC-capable electrical wiring within the building according to claim 5;
And marking terminal ends of the retrofitted wiring using insulation shrink tubing with predefined colors to indicate specific DC voltage potentials, the colors corresponding to the three-conductor electrical wire defined in claim 5.
